(19) United States
(12) Patent Application Publication
(10) Pub. No.: US 2013/0216298 A1
(43) Pub. Date: Aug. 22, 2013

(54) METHOD FOR PRODUCING A CHASSIS COMPONENT

(71) Applicants: Wolfgang Jekel, Hude (DE); Frank Nachbar, Osnabruck (DE); Hauke Frenzel, Markdorf (DE); Ignacio Lobo Casanova, Friedrichshafen (DE); Andreas Temmen, Osnabruck (DE); Christian Stelter, Sulingen (DE)

(72) Inventors: Wolfgang Jekel, Hude (DE); Frank Nachbar, Osnabruck (DE); Hauke Frenzel, Markdorf (DE); Ignacio Lobo Casanova, Friedrichshafen (DE); Andreas Temmen, Osnabruck (DE); Christian Stelter, Sulingen (DE)

(73) Assignee: ZF Friedrichshafen AG, Friedrichshafen (DE)

(21) Appl. No.: 13/881,033

(22) PCT Filed: Sep. 27, 2011
(86) PCT No.: PCT/EP2011/066704

§ 371 Date: Apr. 23, 2013

(30) Foreign Application Priority Data
Oct. 28, 2010 (DE) 10 2010 043 039.0

(51) Int. Cl. B60G 7/00; B62D 65/02

(52) U.S. Cl. CPC B60G 7/005; B62D 65/02
USPC 403/76; 29/897.2; 403/66

(57) ABSTRACT

A method for producing a chassis component. The method comprising process steps of forming a joint holder (15) in a structural component (3); inserting a joint cartridge (5) into the joint holder (15); assembling the joint cartridge (5) to form a joint (2); solidly connecting the structural component (3) to the joint cartridge (5) by welding; and covering the weld zone (18), formed during the welding step, by a sealing bellows (8).

This application is a National Stage completion of PCT/EP2011/066704 filed Sep. 27, 2011, which claims priority from German patent application serial no. 10 2010 043 039.0 filed Oct. 28, 2010.

### FIELD OF THE INVENTION

The invention concerns a method for producing a chassis component, the method having the following process steps:
a joint holder is formed in a structural component,
a joint cartridge is inserted into the joint holder in the structural component,
the joint cartridge is assembled to form a ball joint, and
the structural component is solidly connected to the joint cartridge by welding to form a ball and socket joint.

Furthermore, the invention concerns a chassis component with a structural component in which a joint holder is formed, and a joint cartridge in the form of a ball joint is inserted into the joint holder, and is connected solidly to the structural component by welding to form a ball and socket joint.

### BACKGROUND OF THE INVENTION

A chassis component as a rule comprises a structural component and one or more joints solidly connected thereto. For example such a chassis component can be a two-point control arm, a three-point control arm or a flange joint, such that the joint is integrated in the structural component as a rule by pressing, screwing or riveting. The joint can also be integrated in a one-piece structural component housing. Such a chassis component is affected in particular by the following disadvantages: it occupies more space, it is cost-intensive, the characteristics of the joint fluctuate markedly, it weighs a lot, it has a large number of individual components, it has areas prone to corrosion (for example the roll edge of the joint), substantial inventory of semifinished products must be maintained, and the logistics are complex.

From DE 603 04 709 T2 a wheel suspension arm for a motor vehicle is known, which has a body formed from a stamped sheet connected by a ball joint to a wheel carrier and by means of two mountings to the vehicle body. The ball joint has a lower mounting which is inserted into a housing formed by the body and is in contact by way of a lateral extension with the lateral edge of the housing, and a cover positioned over the lower mounting and connected solidly to the surface of the body by laser welding.

In this wheel suspension, arm tolerances can add up in an unfavorable manner, while the lower mounting and the cover are being assembled onto the body. In addition the body, the lower mounting and if necessary the cover as well have to be cleaned after assembly before a protective coating can be applied on those components. It also involves considerable complexity if the body, the lower mounting and if necessary the cover are provided with different coatings. Moreover, the weld zone is particularly prone to corrosion.

### SUMMARY OF THE INVENTION

Starting from that prior art the purpose of the present invention is to protect a chassis component of the type mentioned to begin with, more effectively against corrosion.

In the method according to the invention for producing a chassis component:
a joint holder is formed on a structural component,
into the joint holder is inserted a joint cartridge,
the joint cartridge is assembled to form a joint,
the structural component and the joint cartridge are solidly connected together by welding, and
the weld zone formed during welding is covered by a sealing bellows.

From the standpoint of vulnerability to corrosion the weld zone is more sensitive than the surfaces of the joint partners consisting of the joint cartridge and the structural component, so the sealing bellows for the chassis component provided protection against corrosion. The sealing bellows covers the weld zone, which is the—or one of the—most corrosion-prone parts of the chassis component so that even if the mating parts are not provided with a corrosion protection coating the sealing bellows provides some corrosion protection for the chassis component. The invention offers the particular advantage that to protect the weld zone against environmental influences the weld zone does not have to be protected by a coating, so that the application of such a coating can be omitted.

The structural component is permanently and solidly connected to the joint cartridge, in particular by one or at least one weld seam formed by the welding process. Advantageously, the weld zone includes the, or the at least one weld seam.

According to a further development of the invention, the structural component is connected permanently and solidly to the joint cartridge by beam welding, in particular by laser beam welding. In this way a particularly low-tolerance connection of the structural component to the joint cartridge can be produced.

In particular the joint cartridge is assembled to form the joint by inserting an interior component of the joint into the joint cartridge and fitting it movably therein. Preferably, the interior component of the joint extends out of the joint cartridge through an opening of the joint cartridge.

Preferably, the joint cartridge is pre-assembled to form the joint. For this, in particular the interior joint component is inserted into the joint cartridge and fitted movably therein before the joint cartridge is inserted into the joint holder and/or connected to the structural component. Thus, independently of the structural component the joint can be produced with great precision. Preferably, the interior joint component extends out of the joint cartridge.

Preferably the joint cartridge is coated, in particular pre-coated. For this, the joint cartridge is provided with a coating in particular before it is inserted into the joint holder and/or before the structural component is connected to the joint cartridge. Preferably the structural component too is coated, in particular pre-coated. For this the structural component is provided with a coating, in particular before the joint cartridge is inserted into the holder and/or before the structural component is connected to the joint cartridge. Advantageously, the coatings of the joint cartridge and the structural component are different. In particular, the joint cartridge and the structural component are coated independently of one another.

Preferably, the joint cartridge and the structural component are coated by different coating methods. The coatings serve in particular to protect the joint cartridge and the structural component against environmental influences such as dirt and moisture. In this way the corrosion protection for the chassis component can be improved still more. Preferably the coatings are protective coatings. Preferably, the joint cartridge is coated before it is preassembled to form the joint.

The structural component is preferably coated by immersion lacquering, in particular by cathodic immersion lacquering. For example, the structural component is coated with a lacquer which, for example, contains an organic material. The joint cartridge is preferably coated by electroplating. For example, the joint cartridge is provided with a zinc-iron coating.

Preferably, the structural component pre-coated on its outside is permanently and solidly connected by welding to the joint cartridge, which is also pre-coated on its outside and preassembled to form a joint. Since the joint cartridge is already preassembled to form a joint and is connected to the structural component, there is no need for individual components of the joint to be fitted onto the structural component. In this way, by integrating the joint in the structural component a tolerance reduction can be achieved compared with DE 603 04 709 T2. Moreover, since the joint cartridge is connected to the structural component by welding, the joint cartridge can be connected to the structural component in a low-tolerance manner. Thereby, greater precision can be achieved than, for example, by pressing, screwing or riveting the joint into or onto the structural component. Finally, the joint cartridge and the structural component are already pre-coated so that, in a simple manner, different coatings can be applied to the joint cartridge and the structural component since they can be coated independently of one another. The handling of the components to be connected to one another is also simplified since the person assembling the joint cartridge and the structural component together can touch and hold them without risk, i.e. without having subsequently to clean these components, which would otherwise have been necessary prior to any coating process because of the contamination arising out of such contact.

The pre-coated structural component and the pre-coated joint cartridge are preferably pretreated before welding. In particular the pre-coated structural component and the pre-coated joint cartridge preassembled to form the joint are pretreated to prepare them for welding. Preferably, the pre-coating of the joint cartridge, in particular that of the joint cartridge after preassembly to form the joint, is partially removed before welding so as to provide an uncoated area on the joint cartridge. Preferably, the joint cartridge is connected to the structural component by welding on its uncoated area. The partial removal of the pre-coating of the joint cartridge is preferably done by laser stripping or by some other stripping process.

In particular, the pre-coating of the structural component is partially removed before welding to provide an uncoated area on the structural component. Preferably, the structural component is connected to the joint cartridge by welding on the uncoated area. It has been shown that partial stripping of the pre-coated joint cartridge and of the pre-coated structural component can be done more cheaply than welding an uncoated joint cartridge to an uncoated structural component. This is because after connecting the uncoated components, as a rule they then have to be cleaned and coated.

According to a further development of the invention the joint holder is formed on the pre-coated structural component, into which joint holder the pre-coated joint cartridge preassembled to form the joint is inserted. In particular, the joint holder is formed on the pre-coated structural component and the pre-coated joint cartridge preassembled to form the joint is inserted into the joint holder before welding. The pre-coating of the structural component is preferably partially removed during the formation of the joint holder.

The joint holder is preferably formed by beam cutting, in particular by laser beam cutting. Since this can be carried out in a manner very little affected by tolerances, the joint holder can be formed and positioned on the structural component with high precision.

Preferably, the joint cartridge is inserted into the joint holder in an axial direction. The joint holder is preferably designed with a circular, or non-circular, square, rectangular or polygonal circumferential contour. The contour is in particular an inner circumferential contour that surrounds the joint cartridge after its insertion into the joint holder. The circumferential contour of the joint holder is preferably matched to fit the outer circumferential contour of the joint cartridge, so the joint cartridge as well is designed with a circular, or non-circular, square, rectangular or polygonal circumferential contour. By forming a non-circular, many-cornered or polygonal circumferential contour, in addition to the material continuity of the weld joint rotation is prevented by positive shape interlock. Moreover, by means of a many-cornered or polygonal circumferential contour a specific rotational position of the joint cartridge relative to the axial direction can be determined. On the other hand, a circular circumferential contour has the advantage that the person assembling the joint can insert the joint cartridge into the joint holder in any angular position relative to the axial direction. Preferably, the connection between the joint cartridge and the structural component formed by welding is strong enough to provide sufficient security against rotation.

The joint holder preferably has a recess into which the joint cartridge is inserted. In a further development of the invention the joint holder comprises or consists of a hole extending through the structural component, into which the joint cartridge is inserted. In particular, the joint holder recess consists of the hole. Preferably, the hole extends in the axial direction through the structural component. The through-going hole can be formed in a simple manner by the beam cutting process mentioned earlier, and thus with high precision.

The joint cartridge preferably has a radial shoulder with which, when the joint cartridge is inserted into the joint holder, it comes into contact in the axial direction against the structural component. In particular, the shoulder rests against an edge of the joint holder. Preferably, the radial width of the shoulder is larger than that of the joint holder or its hole. The contact of the shoulder against the structural component is a positioning aid when the joint cartridge is inserted into the joint holder in the axial direction. The shoulder is in particular an external shoulder. Preferably, the shoulder extends all the way around. Preferably, on its outer circumferential surface the joint cartridge has a surrounding collar on which the shoulder is formed. The term “radial” denotes in particular any direction that extends perpendicularly to the axial direction.

According to a further development of the invention, the outer circumferential surface of the joint cartridge tapers down in the axial direction, at least in part. For example, at least in some areas the outer circumferential surface is conical in the axial direction. The tapered or conical shape of the outer circumferential surface of the joint cartridge is preferably used for centering the joint cartridge during its insertion into the joint holder. Thus for example, possible tolerance variations in the diameter of the joint holder can be compensated for.

Preferably, the structural component is connected solidly to one or more other joints. In one design version of the invention, the structural component is connected solidly to the one or more other joints before the joint holder is formed on the structural component. In particular, the location at which the joint holder is formed on the structural component is determined as a function of the position(s) of the joint(s) solidly connected to the structural component. The, or each of the position(s) is preferably characterized or determined by a kinematic point of the respective other joint. Thus, the location at which the joint holder is formed on the structural component is preferably determined as a function of the kinematic point(s) of the other joint(s) connected solidly to the structural component. In this way it is possible to achieve a clear improvement of precision compared with conventional chassis components in which the joint holder is formed already before the structural component is connected to one or more other joints, since the fitting of each of the other joints is prone to positional inaccuracies. Thus, from the kinematic standpoint a clear improvement compared with the prior art is possible. The one or more other joints preferably comprise or consist of rubber or elastomeric mountings.

In particular the joint is or forms a ball joint. Preferably, the inner component of the joint consists of a ball stud with a joint ball, which with its joint ball is inserted into the joint cartridge and fitted therein so that it can move, preferably before the joint cartridge is connected to the structural component. In particular the ball stud with its joint ball is fitted so that it can rotate and/or swivel in the joint cartridge. Preferably, the ball stud extends out of the joint cartridge through the joint cartridge's opening. In a further development of the invention, the ball stud is fitted so that it can move by sliding in a bearing shell, which is held by the joint cartridge and which is preferably made of plastic.

The wall of the joint cartridge in the area of its opening is preferably curved, in particular bent inward in the direction toward the ball stud. In that case the curved area of the wall is preferably free from the pre-coating of the joint cartridge since otherwise the coating in this area could flake off. Alternatively, in the area of the joint cartridge's opening but also in the direction toward the ball stud the wall of the joint cartridge can be shaped in advance. As another alternative the joint cartridge's opening can also be covered or at least partially covered by a covering collar fixed to the joint cartridge, through which the ball stud extends outward. However, closer tolerances can be achieved by deforming the wall of the joint cartridge in the area of its opening than when a covering collar is used, since no additional component is then needed. The covering collar or pre-shaped or deformed wall area preferably covers the joint ball in the axial direction so that the ball stud is secured in the axial direction within the joint cartridge and in particular cannot be pulled out of the latter. The wall of the joint cartridge is deformed or the covering collar is fixed to the joint cartridge preferably before the joint cartridge is connected to the structural component.

According to feature of the invention the ball stud is inserted into the joint cartridge through the joint cartridge's opening, in particular before the wall of the joint cartridge is deformed toward the ball stud in the area of the opening or before the covering collar is fixed onto the joint cartridge.

According to another feature of the invention the joint cartridge has an assembly opening opposite the joint cartridge's opening, through which the ball stud is inserted into the joint cartridge. This is in particular the case when the wall of the joint cartridge in the area of its opening has been pre-shaped in the direction toward the ball stud. When the ball stud has been inserted into the joint cartridge the assembly opening is closed by a housing cover, in particular before the structural component is connected to the joint cartridge.

The sealing bellows is preferably a joint sealing bellows which in particular seals off the opening of the joint cartridge. Preferably, the inner component of the joint extends outward through the sealing bellows, which advantageously is in contact with the inner component, forming a seal.

The sealing bellows is preferably fixed to and forms a seal against the joint cartridge and/or the structural component. Preferably, the sealing bellows is folded over the joint cartridge and/or over the covering collar and is fixed to it or to them so as to form a seal. Advantageously, the sealing bellows is stretched over the joint cartridge and/or the covering collar. In a development of the invention the sealing bellows is clamped by one or more clamping rings against the joint cartridge and/or the covering collar. In addition or alternatively, the sealing bellows can also be adhesively bonded or vulcanized onto the joint cartridge and/or the covering collar and/or the structural component.

The sealing bellows is made in particular from a flexible material. Preferably, the sealing bellows consists of an elastomer material, especially rubber.

The structural component is preferably made of metal. Moreover, the joint cartridge is also preferably made of metal. If there is a covering collar, then this as well is preferably metallic.

The invention also concerns a chassis component, in particular for a motor vehicle, having:
a structural component on which a joint holder is formed,
a joint cartridge inserted in the joint holder, which is assembled to form a joint and is connected solidly to the structural component by welding,
with the weld zone formed during welding covered by a sealing bellows.

The chassis component according to the invention is in particular made by the method according to the invention and can be developed further in accordance with all the features described in that context.

In particular, an inner joint component is held by the joint cartridge in which it is fitted and able to move. Preferably, the inner joint component extends out of the joint cartridge through an opening in the latter. The sealing bellows seals the joint cartridge's opening. Preferably, the inner joint component extends out through the sealing bellows, which is advantageously fixed against the inner joint component to form a seal.

According to a further development of the invention the opening of the joint cartridge is covered or at least partially covered by a covering collar, which is fixed to the joint cartridge and through which the ball stud extends.

The sealing bellows is preferably fixed to form a seal against the joint cartridge and/or the covering collar and/or the structural component. Preferably, the sealing bellows is folded over the joint cartridge and/or the covering collar and is in contact with it or with them, forming a seal. Advantageously, the sealing bellows is stretched over the joint cartridge and/or the covering collar. In a further development of the invention the sealing bellows is clamped by one or more clamping rings against the joint cartridge and/or against the covering collar. In addition or alternatively, the sealing bellows can also be bonded or vulcanized onto the joint cartridge and/or the covering collar and/or the structural component.

In particular, the joint is or forms a ball joint. Preferably, the inner joint component is a ball stud with a joint ball, which with the joint ball is inserted into the joint cartridge and fitted movably in it. In particular the ball stud with its joint ball is fitted into the joint cartridge so that it can rotate and/or swivel. Preferably, the ball stud extends outward through the opening of the joint cartridge. In a further development of the invention the ball stud is fitted in such manner that the ball can move by sliding in a bearing shell, which is held in the joint cartridge and is preferably made of plastic.

### BRIEF DESCRIPTION OF THE DRAWINGS

Below, the invention is described with reference to preferred embodiments illustrated in the drawings, which show:

FIG. 1: A perspective view of a chassis component according to a first embodiment of the invention,

FIG. 2: A longitudinal section through the chassis component, taken along the section line 2-2 in FIG. 1,

FIG. 3: An enlarged view of the area identified as B in FIG. 2,

FIG. 4: A perspective view of the ball joint in FIG. 1,

FIG. 5: The ball joint of FIG. 4 when it has been inserted into a joint holder of the structural component shown in FIG. 1,

FIG. 6: A partial sectional view of the ball joint inserted in the joint holder, taken along the section line 6-6 in FIG. 5,

FIG. 7: A perspective view of a chassis component according to a second embodiment of the invention,

FIG. 8: A view from above, of the structural component shown in FIG. 7 before the ball joint has been fitted,

FIG. 9: A perspective view of the ball joint in FIG. 7,

FIG. 10: The ball joint of FIG. 9 when it has been inserted into a joint holder of the structural component shown in FIG. 7,

FIG. 11: A partial sectional view of the ball joint inserted in the joint holder, taken along the section line 11-11 in FIG. 10,

FIG. 12: A sectional view of the ball joint along the section line 11-11 in FIG. 10, after the formation of a weld seam,

FIG. 13: A sectional view of the ball joint, taken along the section line 13-13 in FIG. 7,

FIG. 14: A partial sectional view of the ball joint inserted in the joint holder, taken along the section line 6-6 in FIG. 5 or along the section line 11-11 in FIG. 10, such that the ball joint is also shown in a condition only partially inserted into the joint holder,

FIG. 15: A sectional view of a modified ball joint only partially inserted into the joint holder, and

FIG. 16: A sectional view of the ball joint of FIG. 15 when fully inserted into the joint holder.

### DETAILED DESCRIPTION OF THE PREFERRED EMBODIMENTS

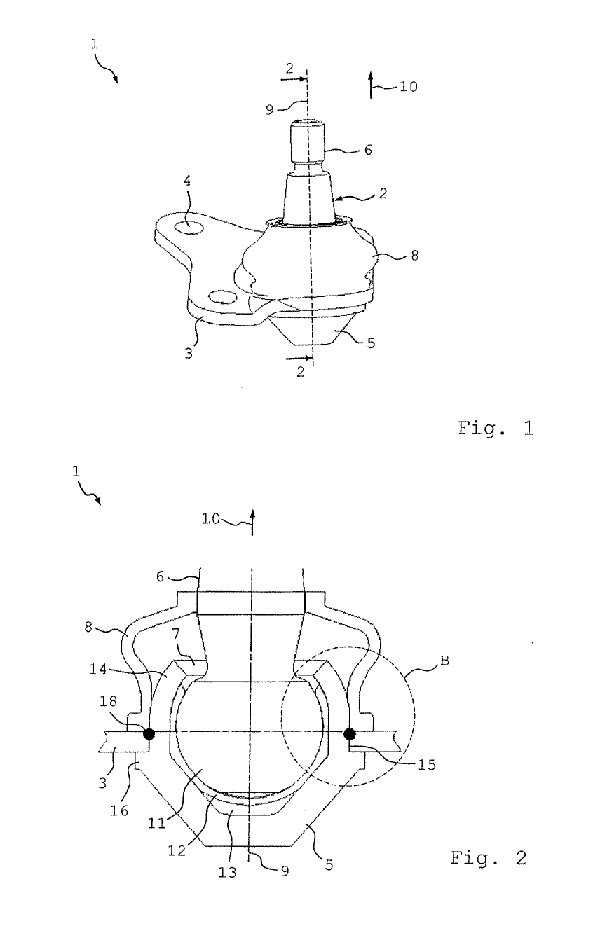

FIGS. 1 to 6 show various views and partial views of a chassis component 1 according to a first embodiment of the invention, such that a ball joint 2 is integrated in a structural component 3. The structural component 3 is in the form of a flange which can be connected solidly to another vehicle component, for which purpose the structural component 3 is provided with a number of through-going holes 4. The ball joint 2 comprises a joint cartridge 5 that serves as the joint housing, in which a ball stud 6 is fitted in such manner that it can rotate and swivel. The ball stud 6 extends through an opening 7 of the joint cartridge (see FIG. 2) out of the joint cartridge 5, and the joint cartridge's opening 7 is sealed by means of a sealing bellows 8, through which the ball stud 6 extends. The longitudinal central axis 9 of the ball joint 2 runs in an axial direction 10, and FIG. 2 shows a sectional view of the chassis component 1 taken along the longitudinal central axis 9.

The ball stud comprises a joint ball which forms one axial end of the ball stud 6 and is fitted to move by sliding in a bearing shell, preferably made of plastic. Together with the joint ball 11, the bearing shell 12 is seated in an inside space 13 of the joint cartridge 5, within which the shell is secured against rotation. Moreover, the wall 14 of the joint cartridge 5 that delimits the inside space 13 is curved in the area of the joint cartridge's opening 7 in the direction toward the ball stud 6. Thus, in the area of the joint cartridge's opening 7 the wall 14 covers the bearing shell 12 and the joint ball 11 in the axial direction 10, so that the ball stud 6 and the bearing shell 12 are secured in the joint cartridge 5 in the axial direction 10. On its side opposite the joint cartridge's opening 7, the bearing shell 12 is in contact with the wall 14.

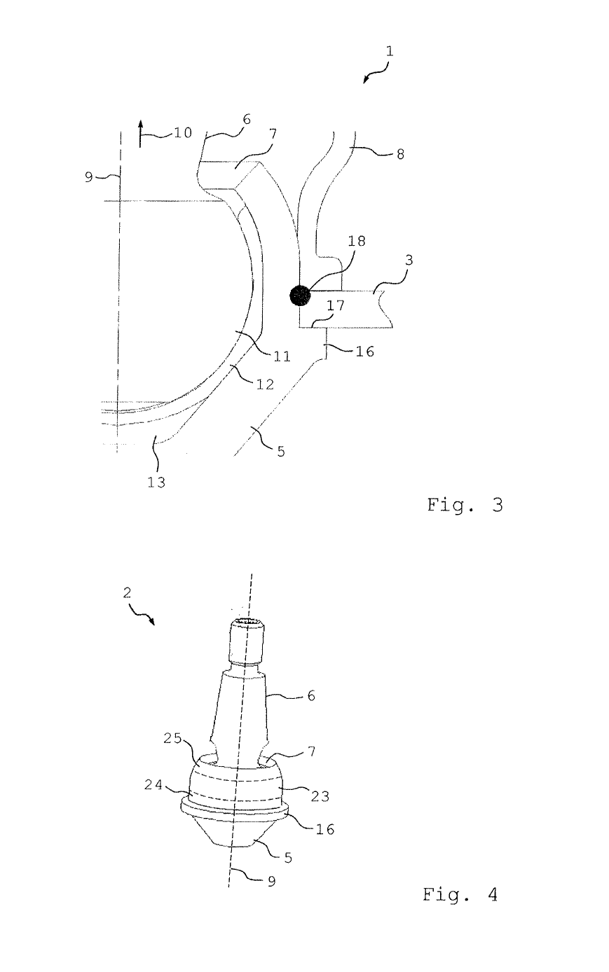

The joint cartridge 5 sits in a joint holder 15, which is in the form of a hole extending through the structural component 3 in the axial direction 10. The joint cartridge 5 has an all-round, radial collar 16, which defines a radially outer shoulder 17 (see FIG. 3) with which the joint cartridge 5 rests against the structural component 3 in the axial direction 10. Thus, the collar 16 secures the joint cartridge 5 on the structural component 3 in the axial direction 10. Moreover, the joint cartridge 5 is welded to the structural component 3, the associated weld seam being indexed 18. The weld seam 18 can be formed all the way round, covering 360°, but that is not strictly necessary.

The sealing bellows 8 surrounding the joint cartridge 5 is in contact with an axial end area against both the joint cartridge 5 and the structural component 3, forming a seal, and thereby covers the weld seam 18. In addition the sealing bellows 8 surrounding the ball stud 6 rests with another axial end area against the ball stud 6 itself, again forming a seal. Thus, the connection area of the ball joint 2 and the structural component 3 is protected against environmental influences. With its circumferential contour (hole wall) 19 that delimits the joint holder 15 (see FIG. 6) the structural component 3 is radially in contact with the joint cartridge 5, so that forces acting radially can be optimally transmitted from the ball joint 2 to the structural component 3 and vice-versa.

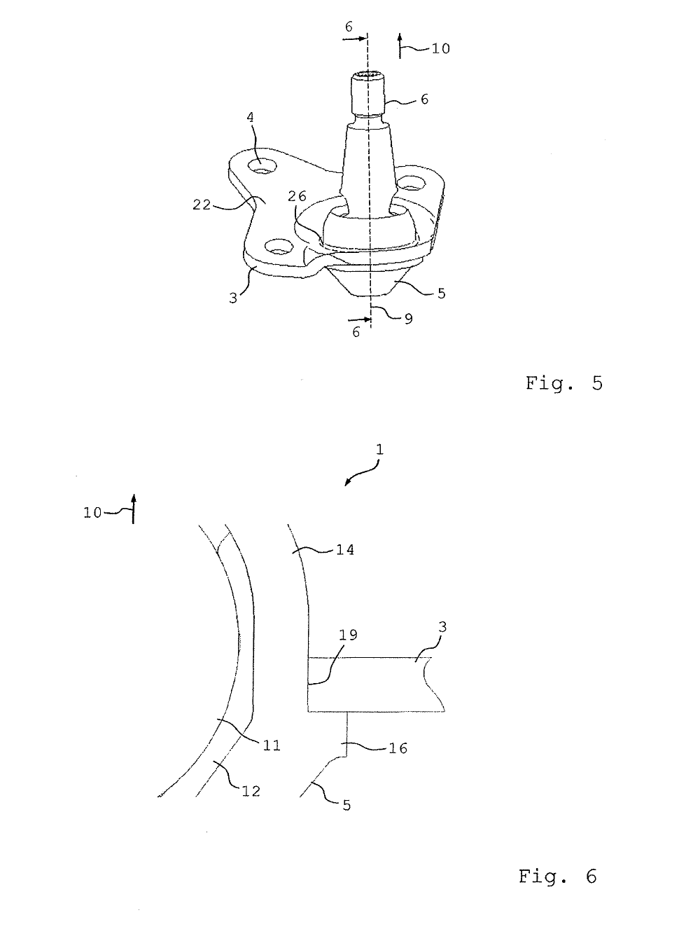

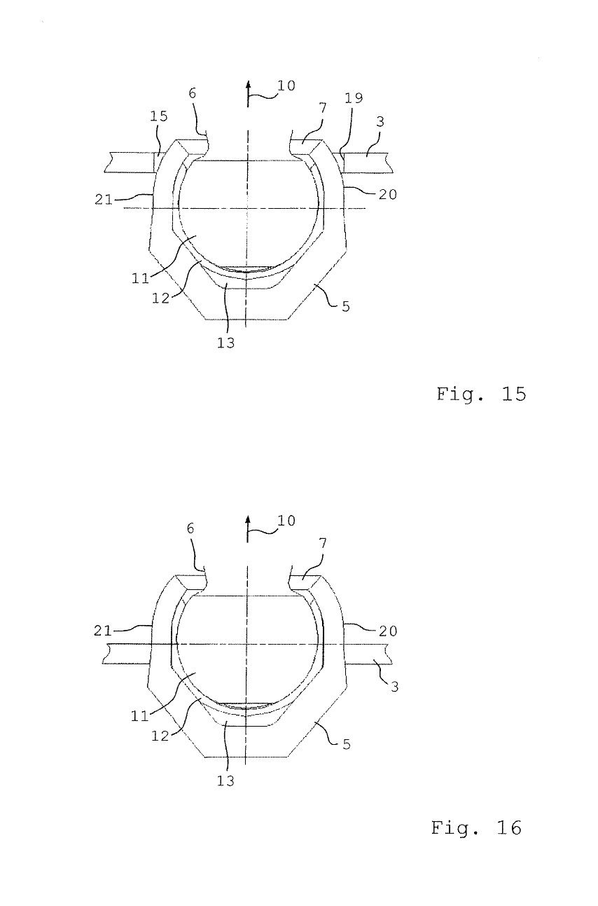

Below, the method according to the invention for producing the chassis component 1 is described. First, the structural component 3 and the ball joint 2 are made independently of one another, the ball joint 2 being illustrated on its own in FIG. 4. Only the sealing bellows 8 has not yet been fixed on the ball joint 2. Then the ball joint 2 is inserted in the axial direction 10, with the ball stud 6 leading, into the joint holder 15 until the collar 16 with its shoulder 17 comes into contact in the axial direction 10 with the structural component 3. This situation can be seen in FIGS. 5 and 6, of which FIG. 6 shows a partial sectional view through the ball joint 2 in its position shown in FIG. 6, the section being taken along the longitudinal central axis 9. During the insertion of the ball joint 2 into the joint holder 15 of the structural component 3, the joint cartridge 5 is preferably centered radially by the curved area of the wall 14. This centering can be seen schematically in FIG. 14, which shows a section through the ball joint 2 along the longitudinal central axis 9. Since the curved part of the wall 14 in the area of the joint cartridge's opening 7 leads to an area of the outer circumferential surface 20 of the joint cartridge 5 that tapers in the axial direction 10 and since the joint cartridge 5 is introduced with its wall area 14 that delimits the joint cartridge's opening 7 ahead into the joint holder 15 of the structural component 3, the interaction of the circumferential contour 19 with the outer circumferential contour 20 brings about a radial centering of the joint cartridge 5. FIG. 14 shows the structural component 3 twice. In a first position I the joint cartridge 5 with its tapering area of the outer circumferential surface 20 is positioned in the joint holder 15. Farther insertion of the joint cartridge 5 into the joint holder 15 in the axial direction 10 brings about the interaction between the circumferential contour 19 and the outer circumferential surface 20, until the joint cartridge 5 is radially centered in the joint holder 15. The joint cartridge 5 is pushed into the joint holder 15 in the axial direction 10 until the shoulder 17 of the collar 16 encounters the structural component 3. This situation is indicated as II. To improve the radial centering, the outer circumferential surface 20 of the joint cartridge 5 can in addition be shaped in part conically in the axial direction 10, as can be seen in FIGS. 15 and 16 which show a modified design of the joint cartridge 5. In this modified design the outer circumferential surface 20 has an area 21 which is conical in the axial direction 10, which is brought into contact with the circumferential contour 19 during the insertion of the joint cartridge 5 into the joint holder 15. This secures the joint cartridge 5 axially in the structural component 3, so that in the modified design the radial collar 16 with the shoulder 17 can be omitted. FIG. 15 shows a situation in which the joint cartridge 5 is only partially inserted into the joint holder 15, whereas FIG. 16 shows the situation when the joint cartridge 5 has been inserted as far as it will go into the joint holder 15.

Once the joint cartridge 5 has been inserted fully into the joint holder 15 of the structural component 3, the weld seam 18 is formed by laser beam welding and the sealing bellows 8 is then fixed onto the ball joint 2.

Before the structural component 3 is welded to the joint cartridge 5, the structural component 3 and the joint cartridge 5 are each provided on their outside with a coating, 22 and 23 respectively, but the coating 23 is removed again in an area 24 by laser stripping before the joint cartridge 5 is welded to the structural component 3. The coating 23 is applied on the outside of the joint cartridge 5 even before the ball stud 6 is inserted into the joint cartridge 5, although an axial end area 25 of the joint cartridge 5 around the joint cartridge's opening 7 is left free from the coating 23. Since the end area 25 is deformed after the insertion of the bearing shell 12 and the joint ball 11, a coating in the area 25 could flake off during the deformation. Furthermore, the coating 22 is applied on the structural component 3 before the joint holder 15 is formed. After applying the coating 22 on the structural component 3 the joint holder 15 is formed in the structural component 3 by laser beam cutting, whereby at the same time the coating 22 is removed in an edge area 26 of the structural component 3 surrounding the joint holder 15. As described earlier, the two components 2 and 3 prepared in that manner can now be inserted one into the other, after which the uncoated areas 24 and 26 are connected solidly to one another by laser beam welding, during which the weld seam 18 is formed. Once the sealing bellows has been put in place, the weld seam 18, the still exposed parts of the areas 24 and 26 and the end area 25 are protected by the sealing bellows 8 against environmental influences.

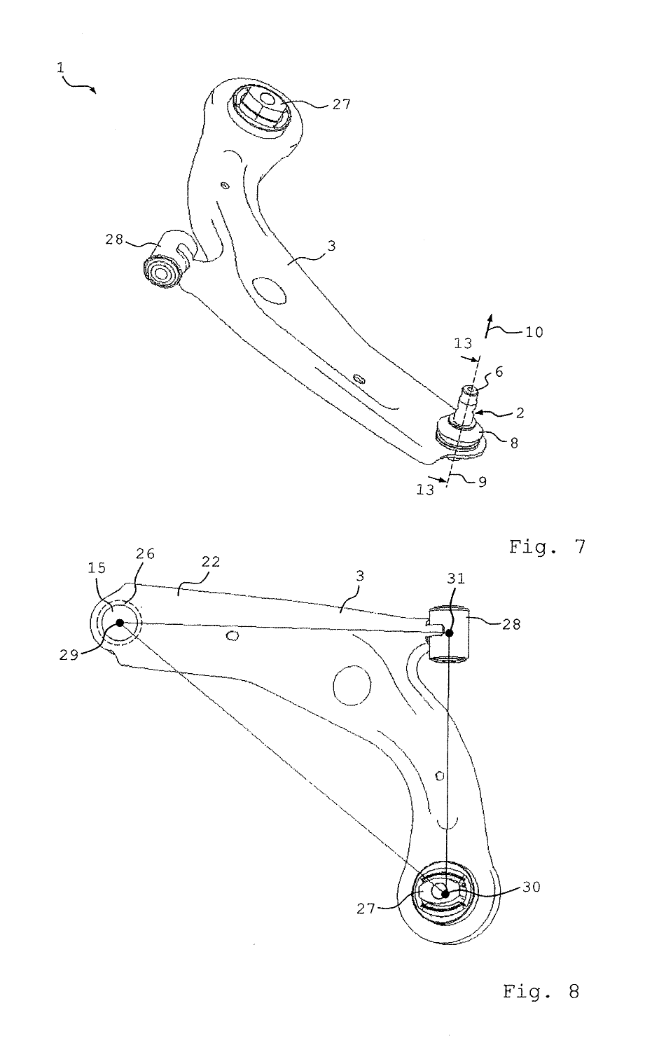

FIGS. 7 to 13 show a chassis component 1 according to a second embodiment of the invention, wherein features similar or identical to those of the first embodiment are denoted with the same indexes as in the first embodiment. FIG. 7 shows a perspective view of the chassis component 1, which is in the form of a three-point control arm and comprises a structural component 3. To the structural component 3 are solidly connected a ball joint 2 and two rubber mountings 27 and 28, the mountings 27 and 28 preferably serve to articulate the chassis component 1 to a vehicle body. The ball joint 2 preferably serves to articulate the chassis component 1 to a wheel carrier.

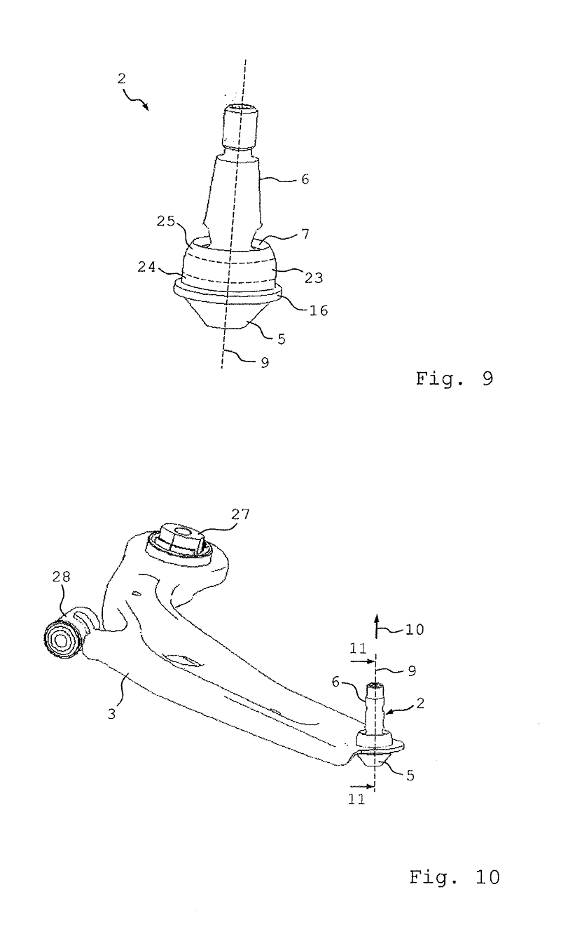

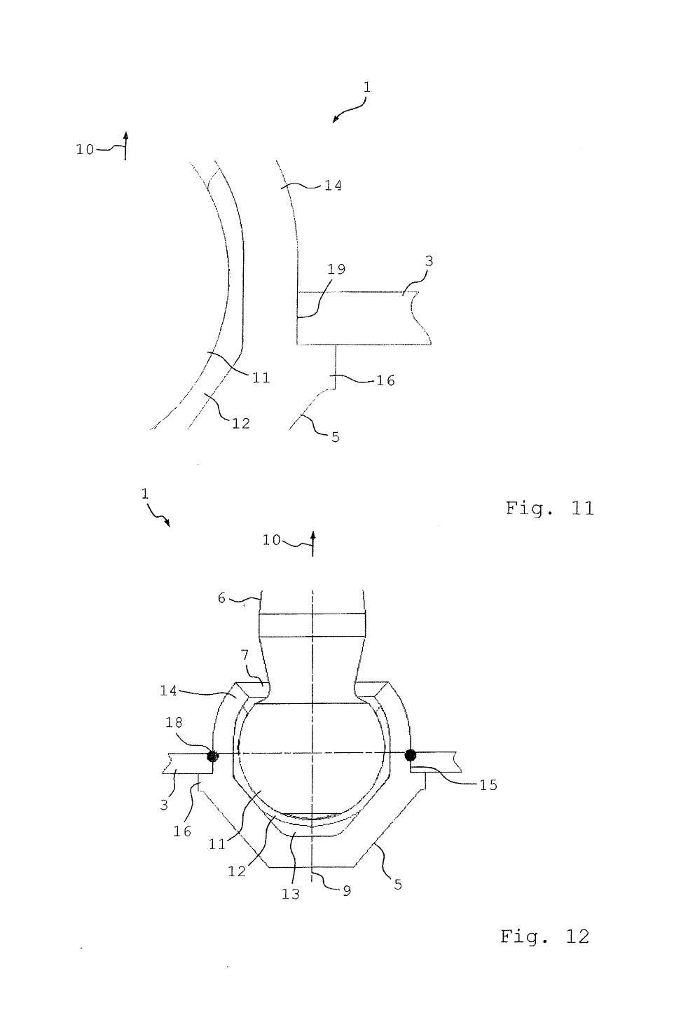

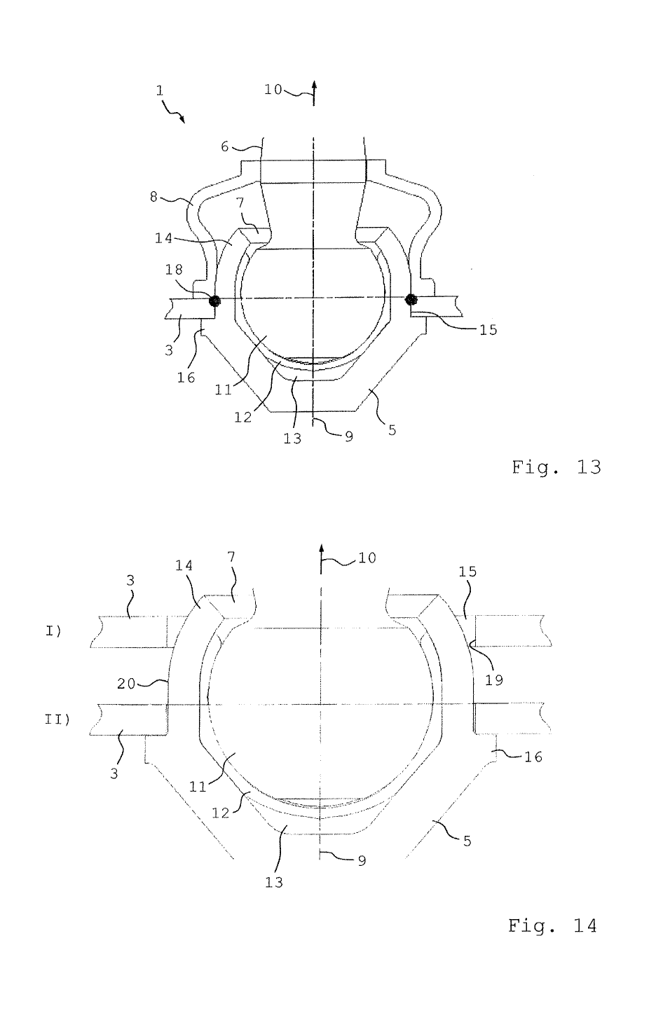

FIG. 8 shows a view of the structural component 3 seen from above, wherein the mountings 27 and 28 are already connected solidly to the structural component 3. In addition a joint holder 15 is shown, which is in the form of a hole extending in an axial direction 10 right through the structural component 3, into which the ball joint 2 is inserted. The insertion of the ball joint 2 into the joint holder 15 and the fixing of the ball joint 2 to the structural component 3 take place analogously to the first embodiment, so that in relation to those processes reference should be made to the description of the first embodiment. Also analogously to the first embodiment, the joint holder 15 is formed in the structural component 3 by laser beam cutting. However, the joint holder 15 is formed only after the structural component 3 has been connected to the mountings 27 and 28. In this case the position 29 where the joint holder 15 is formed is determined as a function of the positions 30 and 31 of the rubber mountings 27 and 28 already connected solidly to the structural component 3. The positions 30 and 31 of the rubber mountings 27 and 28 are in particular represented by their kinematic points. In addition the position 29 preferably represents the location of the kinematic point 2 of the ball joint 2 once it has been solidly connected to the structural component 3. In particular, the position 29 characterizes the mid-point of the joint holder 15. Once the position 29 has been determined, the joint holder 15 is cut into the structural component 3 by laser beam cutting and at the same time the surface coating 22 of the structural component 3 is removed from an area 26 around the joint holder. After this the previously prepared and partially uncoated ball joint 2 is inserted into the joint holder 15 in accordance with FIG. 9, as can be seen in FIG. 10. FIG. 11 shows a section through the ball joint 2 of FIG. 10 taken along the section line 9. Once the ball joint 2 has been inserted into the hole 15 of the structural component 3, the joint cartridge 5 and the structural component 3 are welded to one another in their uncoated areas 24 and 26, forming the weld seam 18 as shown in FIG. 12. Then a sealing bellows 8 is fitted over the ball joint 2. FIG. 13 shows a section through the ball joint 2 of FIG. 7 taken along the section line 9. For any further description of the ball joint 2 and its connection to the structural component 3, reference should be made to the description of the first embodiment.

### LIST OF INDEXES

1 Chassis component
2 Ball joint
3 Structural component
4 Through-going hole in the structural component
5 Joint cartridge
6 Ball stud
7 Opening of the joint cartridge
8 Sealing bellows
9 Longitudinal central axis of the ball joint
10 Axial direction
11 Joint ball of the ball joint
12 Bearing shell
13 Inside space of the joint cartridge
14 Wall of the joint cartridge
15 Joint holder
16 All-round collar of the joint cartridge
17 Radial shoulder
18 Weld seam
19 Circumferential contour of the joint holder
20 Outer circumferential surface of the joint cartridge
21 Conical area of the outer circumferential surface of the joint cartridge
22 Surface coating on the structural component
23 Surface coating on the joint cartridge
24 Stripped area of the joint cartridge
25 Axial end area of the joint cartridge
26 Stripped area of the structural component
27 Rubber mounting
28 Rubber mounting
29 Location of the joint holder
30 Position of the rubber mounting
31 Position of the rubber mounting

1-17. (canceled)

18. A method of producing a chassis component, the method comprising the steps of:
forming a joint holder (15) in a structural component (3);
inserting a joint cartridge (5) into the joint holder (15);
assembling the joint cartridge (5) to form a joint (2);
solidly connecting the joint cartridge (5) to the structural component (3) by welding; and
covering a weld zone (18) formed during the welding with a sealing bellows (8).

19. The method according to claim 18, further comprising the step of coating an outside of both the structural component (3) and the joint cartridge (5).

20. The method according to claim 18, further comprising the step of, before welding, inserting the joint cartridge (5) in an axial direction (10) into the joint holder (15).

21. The method according to claim 20, further comprising the step of either providing the joint holder (15) with a hole or forming the joint holder as a hole that extends axially through the structural component (3).

22. The method according to claim 20, further comprising the step of inserting the joint cartridge (5) axially into the joint holder (15) until a radial shoulder (17) of the joint cartridge (5) engages with the structural component (3).

23. The method according to claim 20, further comprising the step of forming at least a portion of an outer circumferential surface (20) of the joint cartridge (5) with a taper in an axial direction (10).

24. The method according to claim 18, further comprising the step of assembling the joint cartridge (5) to form the joint (2) by inserting an inner joint component into the joint cartridge (5) and fitting the inner joint component so that the inner joint component can move in the joint cartridge (5) in such manner that the inner joint component extends out through an opening (7) of the joint cartridge (5).

25. The method according to claim 24, further comprising the step of forming the inner joint component as a ball stud (6) having a joint ball (11) which with the joint ball is inserted into the joint cartridge (5) such that the ball stud (6) with the joint ball (11) is fitted into and able to move within the joint cartridge (5).

26. The method according to claim 24, wherein fitting the inner joint component in the joint cartridge (5) such that the inner joint component extends through the sealing bellows (8) that seals the opening (7) of the joint cartridge (5).

27. The method according to claim 24, further comprising the step of fitting the sealing bellows (8) over the inner joint component to form a seal.

28. The method according to claim 18, further comprising the step of fitting the sealing bellows (8) over at least one of the joint cartridge (5) and the structural component (3) to form a seal.

29. The method according to claim 18, wherein the sealing bellows (8) consists of a flexible material.

30. A chassis component comprising:
a structural component (3) in which a joint holder (15) being formed;
a joint cartridge (5) being inserted into the joint holder (15), which is assembled to form a joint (2) and being solidly connected to the structural component by welding; and
a sealing bellows (8) covering a weld zone (18) that is formed during the welding process.

31. The chassis component according to claim 30, wherein an inner joint component is inserted into the joint cartridge (5) and fitted therein so that the inner joint component is movable, and such that the inner joint component extends out of the joint cartridge (5) through an opening (7) of the joint cartridge, and the opening is sealed by the sealing bellows (8).

32. The chassis component according to claim 31, wherein the inner joint component is a ball stud (6) with a joint ball (11), which is inserted with its joint ball (11) into the joint cartridge (5) and fitted therein so as to be movable.

33. The chassis component according to claim 31, wherein the inner joint component extends through the sealing bellows (8) which is fitted over the inner joint component to form a seal.

34. The chassis component according to claim 30, wherein the sealing bellows (8) is fitted over at least one of the joint cartridge (5) and the structural component (3) to form a seal.
